(19) United States
(12) Patent Application Publication
(10) Pub. No.: US 2010/0049552 A1
(43) Pub. Date: Feb. 25, 2010

(54) First Notice Of Loss reporting with integrated claim processing

(76) Inventors: Jim Fini, Natick, MA (US); Jon McNeill, Wellesley, MA (US); Jerry S. Straughan, JR., Newton, MA (US)

Correspondence Address: KRISTOFER E. ELBING, 187 PELHAM ISLAND ROAD, WAYLAND, MA, 01778, US

(21) Appl. No.: 12/381,665

(22) Filed: Mar. 13, 2009

Related U.S. Application Data
(60) Provisional application No. 61/069,357, filed on Mar. 14, 2008.
(60) Provisional application No. 61/125,472, filed on Apr. 25, 2008.

(51) Int. Cl. G06Q 40/00; G06Q 20/00; G06F 15/16

(52) U.S. Cl. 705/4; 709/217; 709/227

(57) ABSTRACT

In one general aspect, an insurance claim processing method is disclosed. It includes establishing a communication session over a communication link between a first location for a first insured and a claim processing location, and receiving a first notice of loss communication from the first location at the claim processing location during the communication session over the communication link. It also includes receiving item identification information about a series of different items affected by the loss from the first location at the claim processing location through the communication link, and accessing insurance valuation information about the items at the claim processing location during the communication session.

### CROSS-REFERENCE TO RELATED APPLICATIONS

This application claims the benefit under 35 U.S.C. 19(e) of U.S. provisional application Ser. No. 61/069,357 filed Mar. 14, 2008 which is herein incorporated by reference. This application is also related to the subject matter of commonly owned provisional application Ser. No. 61/067,065, filed Feb. 25, 2008, application Ser. No. ______ filed Feb. 25, 2009 under docket no. E0001-002002, application serial no. PCT/US2009/01205 filed Feb. 25, 2009, and application Ser. No. 61/125,472 filed Apr. 25, 2008, which are all herein incorporated by reference.

### FIELD OF THE INVENTION

This application relates to insurance claim processing and valuation.

### BACKGROUND OF THE INVENTION

Referring to FIG. 2A, prior art contents insurance claims have typically been processed through a multi-part approach. This approach generally begins with what is known as a First Notice of Loss (FNOL), which usually takes the form of a telephone call in which the insured first reports the occurrence of a peril for which he or she seeks coverage. During this call, a member of an FNOL call center will typically access the insured's policy information and enter summary loss data into a claim system to create an FNOL data file.

The FNOL data file will generally be forwarded to an adjuster. For small claims, the adjuster will usually collect a contents inventory from the insured via phone, fax, or e-mail. A transcriptionist typically then transcribes the inventory into a computer, and this inventory is used in a subsequent communication with the insured to settle the claim.

### SUMMARY OF THE INVENTION

In one general aspect, the invention features an insurance claim processing method that includes establishing a communication session over a communication link between a first location for a first insured and a claim processing location, receiving a first notice of loss communication from the first location at the claim processing location during the communication session over the communication link, wherein the notice of loss message is a first communication to report a loss that includes information that identifies a policy and the nature of the loss, receiving item identification information about a series of different items affected by the loss from the first location at the claim processing location through the communication link during the communication session, and accessing insurance valuation information about the items at the claim processing location during the communication session.

In preferred embodiments, the method can further include the step of transmitting an acknowledgement about the insurance valuation information from the claim processing location to the first location during the communication session. The method can further include the step of accessing a series of prompts optimized for fraud detection. The prompts can be derived from a statistical analysis of fraud claim data. The method can further include the step of accessing a series of prompts optimized for item identification. The method can further include the step of accessing a series of prompts optimized for fraud detection and item identification. The series can be dynamically issued based on responses to earlier prompts. The method can further include the step of accessing a series of prompts relating to items not listed by the insured. The step of establishing can establish a telephonic communication and the prompts can be accessed at the claim processing location. The step of establishing can establish a web-based communication and the prompts can be web-based. The method can further include the step of changing the communication session for valuation of specialized contents. The step of changing can include transferring the communication session. The step of establishing can establish a communication link that is capable of voice and data communication with the step of receiving item information including receiving a voice description of the insured item and an image of at least one item. The method can further include the step of compiling a list of item valuations accessed in the step of accessing. The step of compiling can insert live links to external data sources for at least some of the items. The method can further include simultaneously establishing one or more further communication links between at least a second location for a second insured and the claim processing location, a further step of receiving a notice of loss communication, a further step of receiving item identification information, a further step of assessing insurance valuation information, and a further step of transmitting an acknowledgement for each of the further communications. The method can further include the step of accessing policy coverage information at the claim processing location during the communication session. The method can further include the step of initiating a settlement payment transaction during the communication session. The method can further include the step of initiating an item replacement transaction with a third party during the communication session. The method can further include the step of initiating an item refurbishment transaction with a third party during the communication session.

In another general aspect, the invention features an insurance claim processing system that includes at least one policy selection control, at least one loss claim initiation control responsive to user actuation to initiate a claim record for a policy selected using the policy selection control, and at least one item valuation information access control operative to access valuation information for a claim and associate the information with a claim record initiated by the claim initiation control.

In preferred embodiments, the system can further include a communication terminal operative to maintain communication link with an insured. The system can further include policy coverage logic responsive to the claim initiation control and at least one policy coverage confirmation indicator responsive to the policy coverage logic. The system can further include prompting logic operative to issue a series of prompts optimized for item identification. The system can further include prompting logic operative to issue a series of prompts optimized for fraud detection. The system can further include prompting logic operative to issue a series of prompts optimized for item identification and fraud detection. The prompting logic can dynamically issue prompts based on responses to earlier prompts. The policy selection control, the loss claim initiation control, and the item valuation control can be presented in a browser. The policy selection control, the loss claim initiation control, and the item valuation control can be presented in a call center terminal.

In a further general aspect, the invention features a computer-based insurance claim processing system that includes means for establishing a communication session over a communication link between a first location for a first insured and a claim processing location, means for receiving a first notice of loss communication from the first location at the claim processing location during the communication session over the communication link, wherein the notice of loss message is a first communication to report a loss that includes information that identifies a policy and the nature of the loss, means for receiving item identification information about a series of different items affected by the loss from the first location at the claim processing location through the communication link during the communication session, and means for accessing insurance valuation information about the items at the claim processing location during the communication session.

In a another general aspect, the invention features an insurance claim processing method that includes storing a series of prompt records each including prompt text that prompts for information related to a contents loss, statistically processing stored historical claim loss information, and ordering the prompts according to statistical information derived in the step of statistically processing.

In preferred embodiments, the method can further include a step of statistically processing stored item valuation information with the step of ordering also ordering the prompts according to statistical information derived in the step of statistically processing stored valuation information. The step of ordering can operate in real time based on replies to earlier prompts.

In a further general aspect, the invention features a computer-based insurance claim processing system that includes storage for a series of prompt records each including prompt text that prompts for information related to a contents loss, a statistical processor responsive to stored historical claim loss information, and ordering logic operative to order the prompts stored in the storage according to statistical information derived from the statistical processor. In preferred embodiments, the ordering logic can be operative in real time based on replies to earlier prompts.

In another general aspect, the invention features a computer-based insurance claim processing system that includes means for storing a series of prompt records each including prompt text that prompts for information related to a contents loss, means for statistically processing stored historical claim loss information, and means for ordering the prompts according to statistical information derived by the means for statistically processing.

In a further general aspect, the invention features an insurance claim processing method that includes receiving an item identification, prompting for valuation for the item received in the item identification in response to the step of receiving an item identification, receiving a response to the step of prompting, and automatically determining, based on a response received in the step of responding, whether to prompt for further item valuation information or to prompt for fraud detection.

The step of automatically determining can be based on a step of accessing stored information for the identified item.

In another general aspect, the invention features a computer-based insurance claim processing system that includes prompting logic operative to prompt for valuation for an identified item, and determination logic operative to automatically determine, based on a response received for prompts from the prompting logic, whether the prompting logic should prompt for further item valuation information or should prompt for fraud detection. In preferred embodiments, the system further includes item information storage, with the determination logic being responsive to stored information for the identified item.

In a further general aspect, the invention features a computer-based insurance claim processing system that includes means for receiving an item identification, means for prompting for valuation for the item received in the item identification in response to the means for receiving an item identification, means for receiving a response to the means for prompting, and means for automatically determining, based on a response received by the means for receiving a response, whether to prompt for further item valuation information or to prompt for fraud detection.

Systems according to the invention may be advantageous in that they can significantly shorten and improve the quality of contents claims processing. Conducting the valuation of contents claims during the a first notice of loss process may tend to improve the accuracy of the reported contents inventory can be higher because the insured has less time to forget the details of the peril. Early valuation may also have the effect of reducing the incidence of fraud. And the use of valuation information in a combined fraud detection/valuation process can result in highly sensitive fraud detection.

### BRIEF DESCRIPTION OF THE DRAWINGS

FIG. 1 is a block diagram showing parts of an illustrative claims processing system according to the invention;

FIG. 2A is a flowchart showing a prior art claim processing method;

FIG. 2B is a flowchart illustrating a process that can be implemented with an embodiment of the system shown in FIG. 1; and

FIG. 3 is an outline of an illustrative series of prompts for use with the system of FIG. 1.

### DESCRIPTION OF AN ILLUSTRATIVE EMBODIMENT

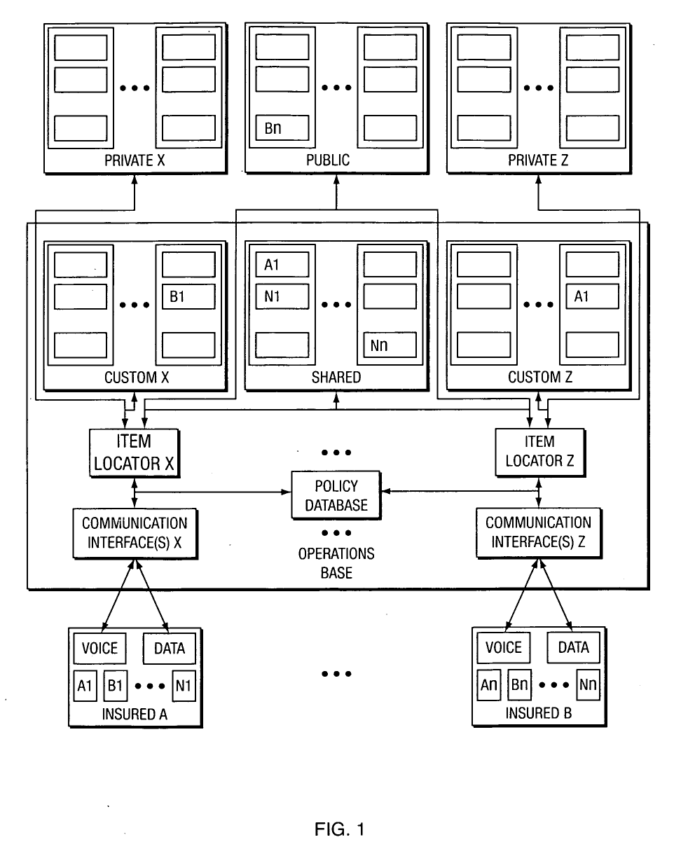

Referring to FIG. 1, an illustrative embodiment of a synchronous valuation system is based on an operations base that can communicate with one or more locations for one or more insured parties. These locations might be the insured sites at issue, such as the insured's home, or they might be another location from which a claim is reported, such as their office. The operations base can be centralized in a single office building, or it can be distributed over a number of locations, which can include home-based telecommuter offices.

The operations base is linked to each of the locations for the insureds via a communications link, such as a telephone line, a wireless telephone channel, and/or a computer network connection. The operations base also includes item locators, which are preferably computerized and provide access to a variety of different data valuation sources. These sources can be developed privately or available publically, and may or may not be available to all of the item locators.

The item locators are preferably integrated with a policy database. This allows first notice of loss data files to created and linked with inventory valuation information as part of a one-call process.

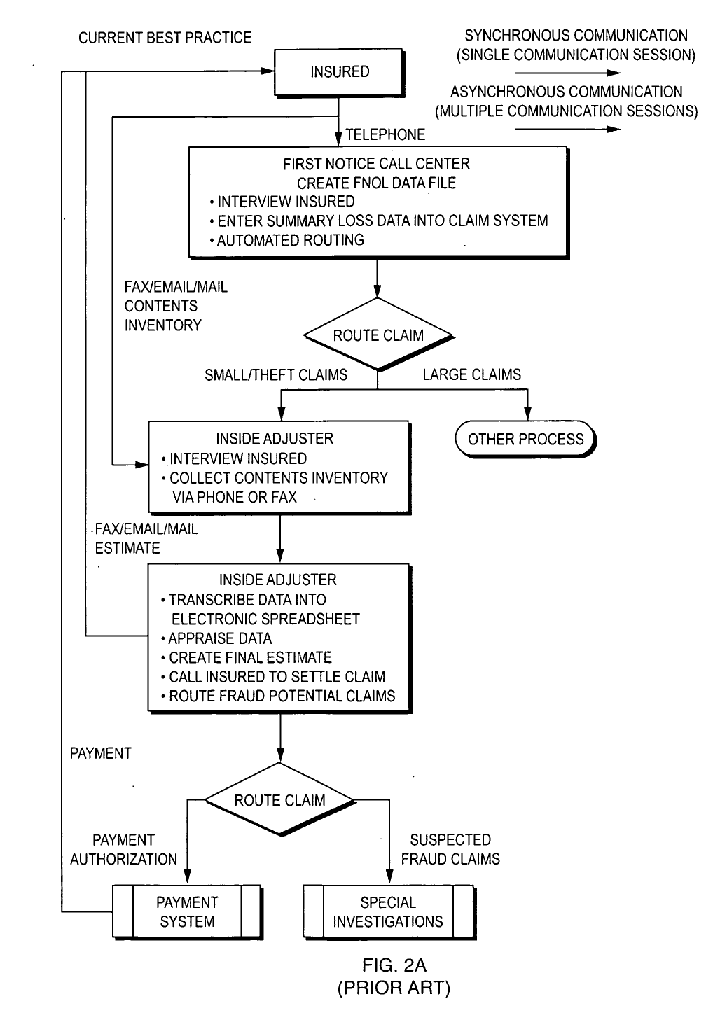

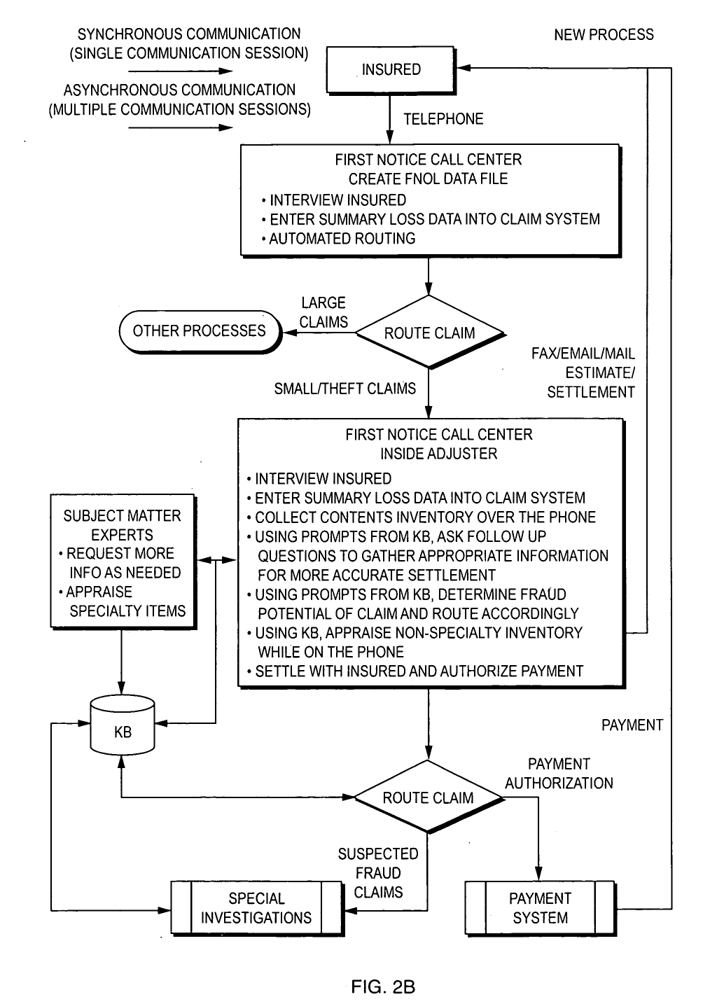

The system can employ different levels of automation. In one embodiment presented in FIG. 2B, the insured and a call center team member and/or adjuster communicate by telephone. But the system could also be more heavily automated, with the call center being replaced with an Interactive Voice Recognition (IVR)-based or web-based first notice of loss reporting interface.

A first notice of loss call can begin with a call center team member creating a FNOL data file. The call can then be transferred to an appraiser, who receives the insured's item inventory and uses the item locator to locate refurbishment prices for items that can be refurbished or replacement (purchase) prices for items that are beyond refurbishment for the claim during the first notice of loss call. Often, replacement valuations can be found at electronic commerce sites on the internet, although other types of valuations sites, such as art appraisal sites, or an appraiser's custom database, can also be consulted. Also, refurbishment prices are also available from private sources, usually repair/restoration service providers local to the insured. As the appraiser locates item valuations, the system builds and stores a list of them. This list can include a replacement value for each item as well as a replacement source for that item. In one embodiment, the list entries can each include a link, such as a URL, to an item page on public replacement source.

Providing replacement and repair/refurbishment valuations during a first notice of loss call can greatly speed up the valuation process while keeping overall cost to a minimum. It can also result in reduced fraud.

If an appraiser is not able to appraise an item, he or she may bring in a subject matter expert. This person can be consulted in a variety of ways, such as by telephone, e-mail, or in a conference call. The insured can also be routed to the expert without the appraiser remaining on the call.

Appraisers or subject matter experts can ask for more information, such as a photo, for a particular item, and the insured can provide the needed information during the first notice of loss call. Items can be processed one at a time, with the appraiser performing a full lookup before another item is discussed, or the list can be built and processed in a more flexible way. Once all of the items have been researched, the adjuster can settle the claim.

Some or all of the information about the items can be sent back to the insured. He or she can use this information to help evaluate an item (does it look more like photo A or photo B?). Some or all of the valuation information can also be communicated to the insured at the field location.

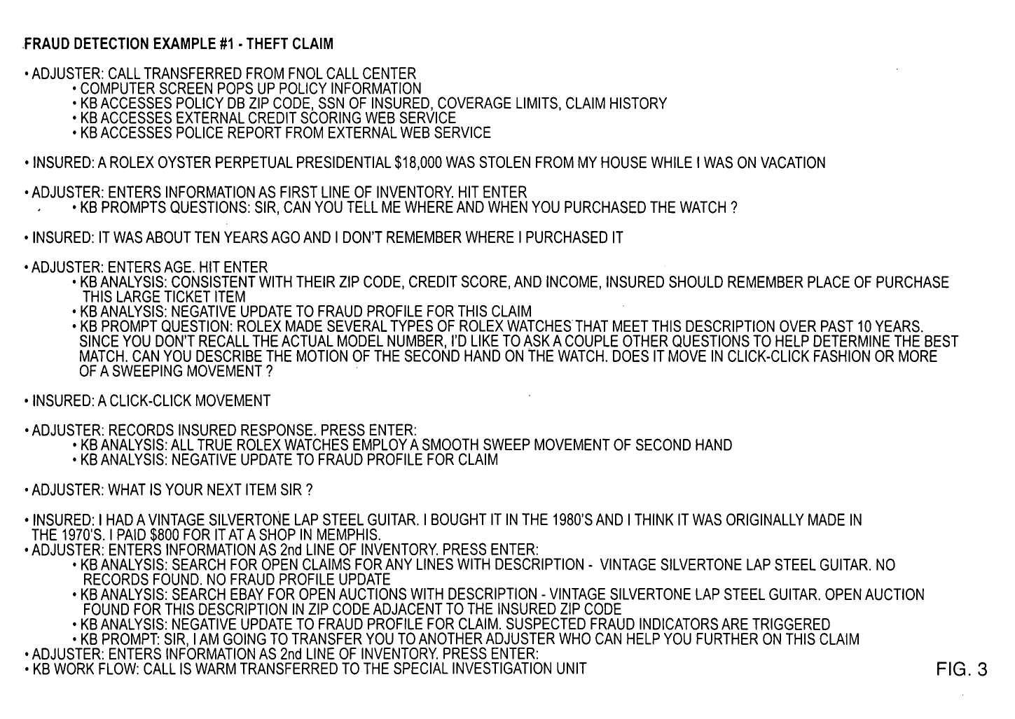

Referring to FIG. 3, the system should preferably provide prompting for the insured. This can take different forms, such as computer-generated scripts for call center team members or web-based controls for the insured. These prompts are preferably optimized to acquire the maximum amount of information with as little customer input as possible. To this end, a statistically optimized attribute system can be used to help focus on the most important attributes of an item, such as in the manner described in the above-referenced prior filed provisional application. The prompting can also be optimized to prevent fraud by statistically optimizing information from a knowledge base derived from prior fraud claims.

The system can also employ combined valuation and fraud detection, which are preferably adaptively interleaved. If a line item being valued includes a UPC code that is inconsistent with its purchase date, for example, the system may introduce a few fraud detection questions, or even transfer the call to a fraud investigation unit.

The system described above has been implemented in connection with a special-purpose software program running on a general-purpose computer platform, but it could also be implemented in whole or in part using special-purpose hardware. And while the system can be broken into the series of modules and steps shown in the various figures for illustration purposes, one of ordinary skill in the art would recognize that it is also possible to combine them and/or split them differently to achieve a different breakdown. In addition, as discussed above, different levels of automation can also be used in the various parts of the system.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. An insurance claim processing method, comprising:
establishing a communication session over a communication link between a first location for a first insured and a claim processing location,
receiving a first notice of loss communication from the first location at the claim processing location during the communication session over the communication link, wherein the notice of loss message is a first communication to report a loss that includes information that identifies a policy and the nature of the loss,
receiving item identification information about a series of different items affected by the loss from the first location at the claim processing location through the communication link during the communication session, and
accessing insurance valuation information about the items at the claim processing location during the communication session.

2. The method of claim further including the step of transmitting an acknowledgement about the insurance valuation information from the claim processing location to the first location during the communication session.

3. The method of claim 1 further including the step of accessing a series of prompts optimized for fraud detection.

4. The memory of claim 3 wherein the prompts are derived from a statistical analysis of fraud claim data.

5. The method of claim 1 further including the step of accessing a series of prompts optimized for item identification.

6. The method of claim 1 further including the step of accessing a series of prompts optimized for fraud detection and item identification.

7. The method of claim 6 wherein the series is dynamically issued based on responses to earlier prompts.

8. The method of claim 1 further including the step of accessing a series of prompts relating to items not listed by the insured.

9. The method of claim 1 wherein the step of establishing establishes a telephonic communication and wherein the prompts are accessed at the claim processing location.

10. The method of claim 1 wherein the step of establishing establishes a web-based communication and wherein the prompts are web-based.

11. The method of claim 1 further including the step of changing the communication session for valuation of specialized contents.

12. The method of claim 11 wherein the step of changing includes transferring the communication session.

13. The method of claim 1 wherein the step of establishing establishes a communication link that is capable of voice and data communication and wherein the step of receiving item information includes receiving a voice description of the insured item and an image of at least one item.

14. The method of claim 1 further including the step of compiling a list of item valuations accessed in the step of accessing.

15. The method of claim 1 wherein the step of compiling inserts live links to external data sources for at least some of the items.

16. The method of claim 1 further including steps of simultaneously establishing one or more further communication links between at least a second location for a second insured and the claim processing location, and further including further steps of receiving a notice of loss communication, receiving item identification information, assessing insurance valuation information, and transmitting an acknowledgement for each of the further communications.

17. The method of claim 1 further including the step of accessing policy coverage information at the claim processing location during the communication session.

18. The method of claim 1 further including the step of initiating a settlement payment transaction during the communication session.

19. The method of claim 1 further including the step of initiating an item replacement transaction with a third party during the communication session.

20. The method of claim 1 further including the step of initiating an item refurbishment transaction with a third party during the communication session.

21. A computer-based insurance claim processing apparatus, comprising:
at least one policy selection control,
at least one loss claim initiation control responsive to user actuation to initiate a claim record for a policy selected using the policy selection control, and
at least one item valuation information access control operative to access valuation information for a claim and associate the information with a claim record initiated by the claim initiation control.

22. The apparatus of claim 21 further including a communication terminal operative to maintain communication link with an insured.

23. The apparatus of claim 21 further including policy coverage logic responsive to the claim initiation control and at least one policy coverage confirmation indicator responsive to the policy coverage logic.

24. The apparatus of claim 21 further including prompting logic operative to issue a series of prompts optimized for item identification.

25. The apparatus of claim 21 further including prompting logic operative to issue a series of prompts optimized for fraud detection.

26. The apparatus of claim 21 further including prompting logic operative to issue a series of prompts optimized for item identification and fraud detection.

27. The apparatus of claim 26 wherein the prompting logic dynamically issues prompts based on responses to earlier prompts.

28. The apparatus of claim 21 wherein the policy selection control, the loss claim initiation control, and the item valuation control are presented in a browser.

29. The apparatus of claim 21 wherein the policy selection control, the loss claim initiation control, and the item valuation control are presented in a call center terminal.

30. A computer-based insurance claim processing apparatus, comprising:
means for establishing a communication session over a communication link between a first location for a first insured and a claim processing location,
means for receiving a first notice of loss communication from the first location at the claim processing location during the communication session over the communication link, wherein the notice of loss message is a first communication to report a loss that includes information that identifies a policy and the nature of the loss,
means for receiving item identification information about a series of different items affected by the loss from the first location at the claim processing location through the communication link during the communication session, and
means for accessing insurance valuation information about the items at the claim processing location during the communication session.

31. An insurance claim processing method, comprising:
storing a series of prompt records each including prompt text that prompts for information related to a contents loss,
statistically processing stored historical claim loss information, and
ordering the prompts according to statistical information derived in the step of statistically processing.

32. The method of claim 31 further including a step of statistically processing stored item valuation information and wherein the step of ordering also orders the prompts according to statistical information derived in the step of statistically processing stored valuation information.

33. The method of claim 31 wherein the step of ordering operates in real time based on replies to earlier prompts.

34. A computer-based insurance claim processing apparatus, comprising:
storage for a series of prompt records each including prompt text that prompts for information related to a contents loss,
a statistical processor responsive to stored historical claim loss information, and
ordering logic operative to order the prompts stored in the storage according to statistical information derived from the statistical processor.

35. The apparatus of claim 34 wherein the ordering logic is operative in real time based on replies to earlier prompts.

36. A computer-based insurance claim processing apparatus, comprising:
means for storing a series of prompt records each including prompt text that prompts for information related to a contents loss,
means for statistically processing stored historical claim loss information, and
means for ordering the prompts according to statistical information derived by the means for statistically processing.

37. An insurance claim processing method, comprising:
receiving an item identification,
prompting for valuation for the item received in the item identification in response to the step of receiving an item identification,
receiving a response to the step of prompting, and
automatically determining, based on a response received in the step of responding, whether to prompt for further item valuation information or to prompt for fraud detection.

38. The method of claim 37 wherein the step of automatically determining is based on a step of accessing stored information for the identified item.

39. A computer-based insurance claim processing apparatus, comprising:
prompting logic operative to prompt for valuation for an identified item, and
determination logic operative to automatically determine, based on a response received for prompts from the prompting logic, whether the prompting logic should prompt for further item valuation information or should prompt for fraud detection.

40. The apparatus of claim 39 further including item information storage and wherein the determination logic is responsive to stored information for the identified item.

41. A computer-based insurance claim processing apparatus, comprising:
means for receiving an item identification,
means for prompting for valuation for the item received in the item identification in response to the means for receiving an item identification,
means for receiving a response to the means for prompting, and
means for automatically determining, based on a response received by the means for receiving a response, whether to prompt for further item valuation information or to prompt for fraud detection.
